(19) United States
(12) Patent Application Publication
(10) Pub. No.: US 2023/0222503 A1
(43) Pub. Date: Jul. 13, 2023

(54) SERVER, SYSTEM AND METHOD FOR CONTROLLING TRANSACTIONS AND RELATED DATA

(71) Applicant: PAYDALA, INC., Scottsdale, AZ (US)

(72) Inventors: Inder P. Singh, Seattle, WA (US); Amit Sethi, Fremont, CA (US)

(21) Appl. No.: 18/151,868

(22) Filed: Jan. 9, 2023

Related U.S. Application Data
(60) Provisional application No. 63/297,407, filed on Jan. 7, 2022.

(51) Int. Cl. G06Q 20/40

(52) U.S. Cl. CPC G06Q 20/4015

(57) ABSTRACT

The disclosed systems, servers and methods provide a novel transaction management framework that is configured to electronically manage, enable and/or control electronic transactions and their related data pursuant to current regulatory statutes, laws and legislature (e.g., Wire Act). In some embodiments, all transactions are controlled in a novel manner so as to require them remain within (e.g., originate within, be processed within and/or complete within) a desired (or required) geographic region or other desired (or required) boundary. Some embodiments reliably restrict all transactions and related data to a specific geographic area which is governed by one or more specific regulatory entities.

### CROSS REFERENCE TO RELATED APPLICATIONS

The present application claims priority to U.S. App. No. 63/297,407, filed Jan. 7, 2022, the contents of which are hereby incorporated by reference in their entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

Some embodiments provide a server, system and computer-based method for electronically managing, enabling and/or controlling electronic transactions and related data to help ensure regulatory compliance.

### BACKGROUND

Regulatory requirements continue to evolve over time, and compliance has become complex and burdensome.

### SUMMARY

The present disclosure provides computerized systems and methods that eliminate manual compliance steps and improve existing computerized systems so as to enable more computationally efficient, accurate and effective compliance with regulatory requirements.

According to some embodiments, the disclosed systems and methods provide a novel transaction management framework that is configured to electronically manage, enable and/or control electronic transactions and their related data pursuant to current regulatory statutes, laws and legislature (e.g., Wire Act). In some embodiments, all transactions are controlled in a novel manner so as to require them remain within (e.g., originate within, be processed within and/or complete within) a desired (or required) geographic region or other desired (or required) boundary. Some embodiments reliably restrict all transactions and related data to a specific geographic area which may be governed by one or more specific regulatory entities.

Some embodiments provide a method for electronically managing, enabling and/or controlling electronic transactions and related data to help ensure regulatory compliance.

Some embodiments provide a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device (e.g., a server(s)) cause at least one processor to perform a method, similar to a method discussed above, for electronically managing, enabling and/or controlling electronic transactions and related data to help ensure regulatory compliance.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 is a schematic diagram illustrating an example of a network within which the systems and methods disclosed herein could be implemented according to some embodiments of the present disclosure;

FIG. 3 depicts is a schematic diagram illustrating an example of client device according to some embodiments of the present disclosure;

FIG. 4 is a block diagram illustrating components of an exemplary system according to some embodiments of the present disclosure;

FIG. 5 is a non-limiting example data flow according to some embodiments of the present disclosure;

FIG. 6 illustrates a non-limiting embodiment of a process of player-related steps according to some embodiments of the present disclosure; and

FIG. 7 illustrates a non-limiting sports betting/gaming transaction data flow according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, Bluetooth, 802.11b/g/n, or the like. Network access technologies may enable wide area coverage for devices, such as client devices with varying degrees of mobility, for example.

In short, a wireless network may include any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

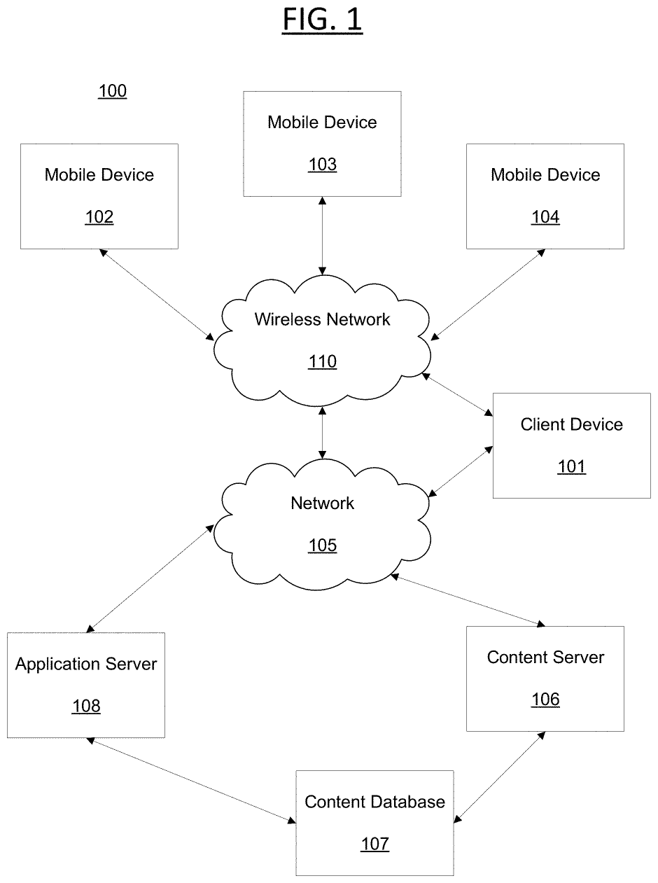

Certain embodiments will now be described in greater detail with reference to the figures. In general, with reference to FIG. 1, a system 100 in accordance with some embodiments of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106 and application (or “App”) server 108.

Some embodiments of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In some embodiments, such communications may include sending and/or receiving messages, creating and uploading documents, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

In some embodiments, wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

In some embodiments, network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

In some embodiments, the content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. In some embodiments, content server 106 can further provide a variety of services that include, but are not limited to, gaming services, betting services, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example the gaming and/or betting services and platform(s), can be provided via application server 108 and/or content server 106.

In some embodiments, central server includes one or more of a content delivery network (CDM) and a meet me at rooms (MMR) networking system. In some embodiments, the central server includes a single server (or physical location comprising a one or more servers) where one or more internet service providers (ISPs) terminate, link, and/or communicate with each other. This creates a physical (meeting) place where all data transmitted between connections, players, and/or users occurs, which satisfies one or more regulatory compliance requirements described herein according to some embodiments. In some embodiments, this effectively takes communication off of the open internet where server connection location is uncertain and directs the communication to a pre-determined location and/or server.

In some embodiments, users are able to access services provided by servers 106 and 108. This may include in a non-limiting example, authentication servers, application servers, search servers, email servers, social networking services servers, SMS servers, IM servers, MMS servers, exchange servers, and the like, via the network 105 using their various devices 101-104.

In some embodiments, application server 108, for example, can store various types of applications and application related information including application data and user profile information (e.g., identifying, generated and/or observed information associated with a user).

In some embodiments, content server 106 and app server 108 can store various types of data related to the content and services each provide, observe, identify, determine, generate, modify, retrieve and/or collect. Such data can be stored in an associated content database 107, as discussed in more detail below.

In some embodiments, server 106 and/or 108 can be embodied as a cloud server or configured for hosting cloud services, as discussed herein.

In some embodiments, the network 105 is also coupled with/connected to a Trusted Search Server (TSS) which can be utilized to render content in accordance with the embodiments discussed herein. Embodiments exist where the TSS functionality can be embodied within servers 106 and 108.

Moreover, although FIG. 1 illustrates servers 106 and 108 as single computing devices, respectively, the disclosure is not so limited. For example, one or more functions of servers 106 and 108 may be distributed across one or more distinct computing devices. Moreover, in some embodiments, servers 106 and 108 may be integrated into a single computing device, without departing from the scope of the present disclosure.

Additionally, while the illustrated embodiment in FIG. 1 depicts only servers 106 and 108, it should not be construed as limiting, as any type and number of servers can be included therein.

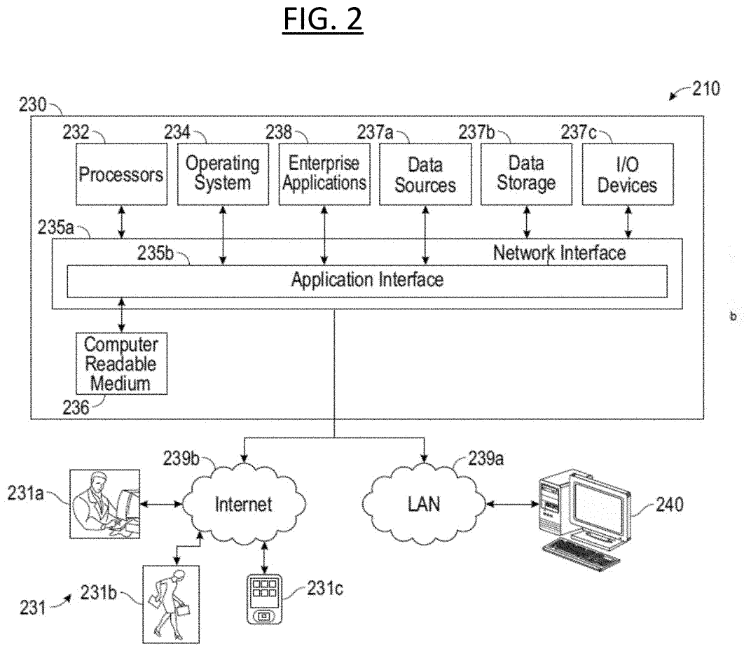

Turning to FIG. 2, computer system 210 is depicted and is a non-limiting example embodiment of system 100 discussed above in relation to FIG. 1.

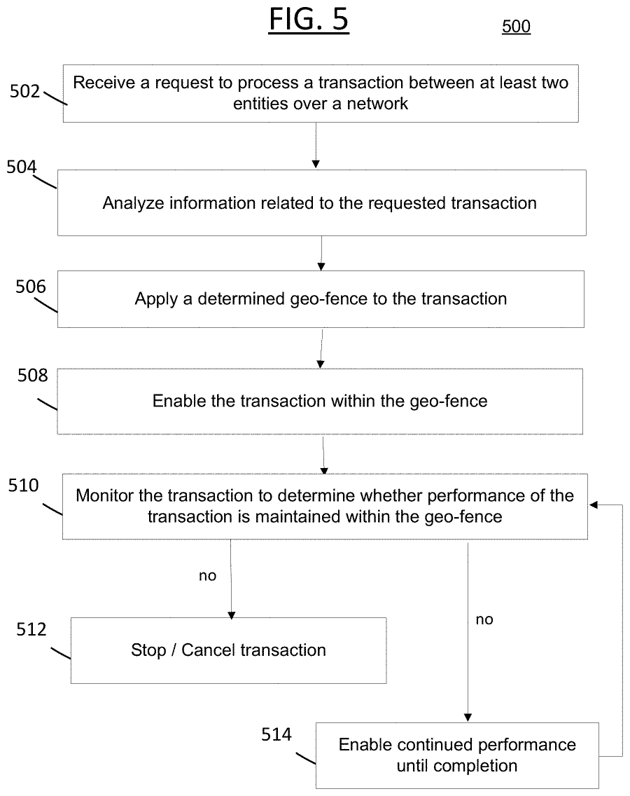

FIG. 2 illustrates a computer system 210 enabling or operating an embodiment of system 100 of FIG. 1, as discussed below (see also FIG. 5, discussed below). In some embodiments, computer system 210 can include and/or operate and/or process computer-executable code of one or more of the above-mentioned program logic, software modules, and/or systems. Further, in some embodiments, the computer system 210 can operate and/or display information within one or more graphical user interfaces. In some embodiments, the computer system 210 can comprise a cloud server and/or can be coupled to one or more cloud-based server systems.

In some embodiments, the system 210 can comprise at least one computing device 230 including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as enterprise applications). In some embodiments, the software modules 238 can include server-based software, and can operate to host at least one user account and/or at least one client account, and operating to transfer data between one or more of these accounts using the at least one processor 232.

With the above embodiments in mind, it should be understood that some embodiments can employ various computer-implemented operations involving data stored in computer systems. Moreover, the above-described databases and models described throughout can store analytical models and other data on computer-readable storage media within the system 210 and on computer-readable storage media coupled to the system 210. In addition, the above-described applications of the system can be stored on non-transitory computer-readable storage media within the system 210 and on computer-readable storage media coupled to the system 210.

In some embodiments, the system 210 can comprise at least one non-transitory computer readable medium 236 coupled to at least one data source 237a, and/or at least one data storage device 237b, and/or at least one input/output device 237c. In some embodiments, the disclosed systems and methods can be embodied as computer readable code on a computer readable medium 236. In some embodiments, the computer readable medium 236 can be any data storage device that can store data, which can thereafter be read by a computer system (such as the system 210). In some embodiments, the computer readable medium 236 can be any physical or material medium that can be used to tangibly store the desired information or data or instructions and which can be accessed by a computer or processor 232. In some embodiments, at least one of the software modules 238 can be configured within the system to output data to at least one user 231 via at least one graphical user interface rendered on at least one digital display.

In some embodiments, the non-transitory computer readable medium 236 can be distributed over a conventional computer network via the network interface 235a where the system embodied by the computer readable code can be stored and executed in a distributed fashion. For example, in some embodiments, one or more components of the system 210 can be coupled to send and/or receive data through a local area network (“LAN”) 239a and/or an internet coupled network 239b (e.g., such as a wireless internet). In some further embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of user devices such as personal computers including for example desktop computers, and/or laptop computers, or any fixed, generally non-mobile internet appliances coupled through the LAN 239a. For example, some embodiments include personal computers 240a coupled through the LAN 239a that can be configured for any type of user including an administrator. Other embodiments can include personal computers coupled through network 239b. In some further embodiments, one or more components of the system 210 can be coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 231a coupled to the system 210 using a desktop computer, and/or laptop computers, or any fixed, generally non-mobile internet appliances coupled through the internet 239b. In some embodiments, the user 231 can comprise a mobile user 231b coupled to the system 210. In some embodiments, the user 231b can use any mobile computing device 231c to wirelessly coupled to the system 210, including, but not limited to, personal digital assistants, and/or cellular phones, mobile phones, or smart phones, and/or pagers, and/or digital tablets, and/or fixed or mobile internet appliances.

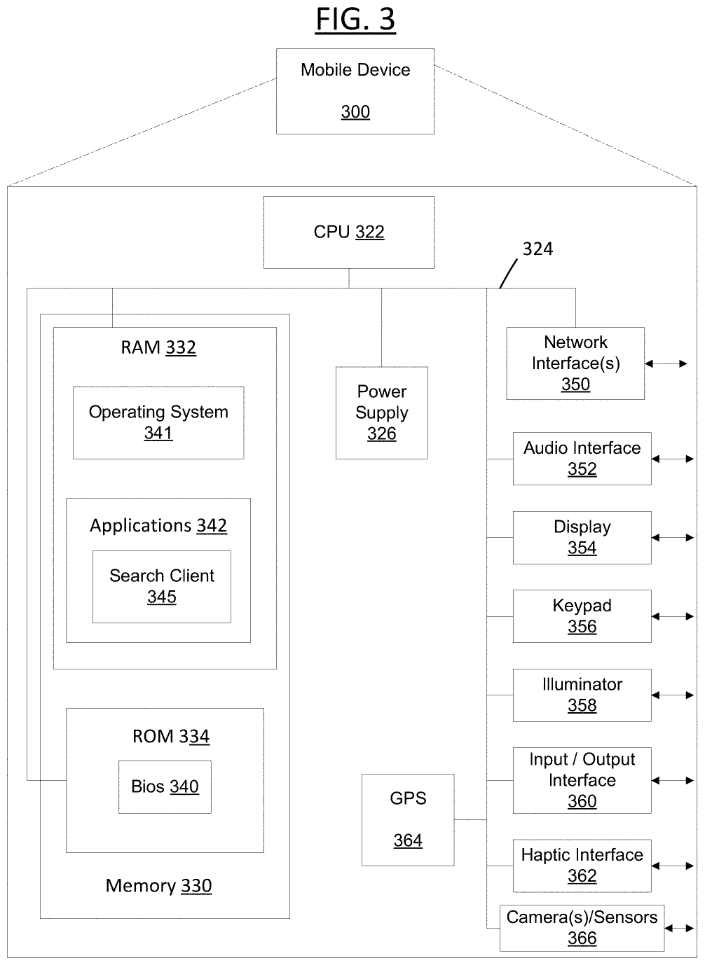

FIG. 3 is a schematic diagram illustrating a client device showing an example embodiment of a client device that may be used within the present disclosure. Client device 300 may include many more or fewer components than those shown in FIG. 3. However, the components shown are sufficient to disclose an illustrative embodiment for implementing the present disclosure. Client device 300 may represent, for example, client devices discussed above in relation to FIGS. 1-2.

As shown in FIG. 3, in some embodiments, client device 300 includes a processing unit (CPU) 322 in communication with a mass memory 330 via a bus 324. In some embodiments, client device 300 also includes a power supply 326, one or more network interfaces 350, an audio interface 352, a display 354, a keypad 356, an illuminator 358, an input/output interface 360, a haptic interface 362, an optional global positioning systems (GPS) receiver 364 and a camera(s) or other optical, thermal or electromagnetic sensors 366. Device 300 can include one camera/sensor 366, or a plurality of cameras/sensors 366, as understood by those of skill in the art. Power supply 326 provides power to the client device 300.

Client device 300 may optionally communicate with a conventional base station (not shown), or directly with another computing device. Network interface 350 is sometimes known as a transceiver, transceiving device, or network interface card (NIC).

In some embodiments, audio interface 352 is arranged to produce and receive audio signals such as the sound of a human voice. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

Keypad 356 may comprise any input device arranged to receive input from a user. Illuminator 358 may provide a status indication and/or provide light.

In some embodiments, client device 300 also comprises input/output interface 360 for communicating with external. Input/output interface 360 can utilize one or more communication technologies, such as USB, infrared, Bluetooth™, or the like. In some embodiments, haptic interface 362 is arranged to provide tactile feedback to a user of the client device.

Optional GPS transceiver 364 can determine the physical coordinates of client device 300 on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS or the like, to further determine the physical location of Client device 300 on the surface of the Earth. In some embodiments, however, the client device 300 may through other components, provide other information that may be employed to determine a physical location of the device, including for example, a MAC address, Internet Protocol (IP) address, or the like.

In some embodiments, mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of client device 300. The mass memory also stores an operating system 341 for controlling the operation of client device 300.

In some embodiments, memory 330 further includes one or more data stores, which can be utilized by client device 300 to store, among other things, applications 342 and/or other information or data. For example, data stores may be employed to store information that describes various capabilities of client device 300. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 300.

In some embodiments, applications 342 may include computer executable instructions which, when executed by client device 300, transmit, receive, and/or otherwise process audio, video, images, and enable telecommunication with a server and/or another user of another client device. In some embodiments, applications 342 may further include search client 345 that is configured to send, to receive, and/or to otherwise process a search query and/or search result.

Having described the components of the general architecture employed within some embodiments, the components' general operation with respect to some embodiments will now be described below.

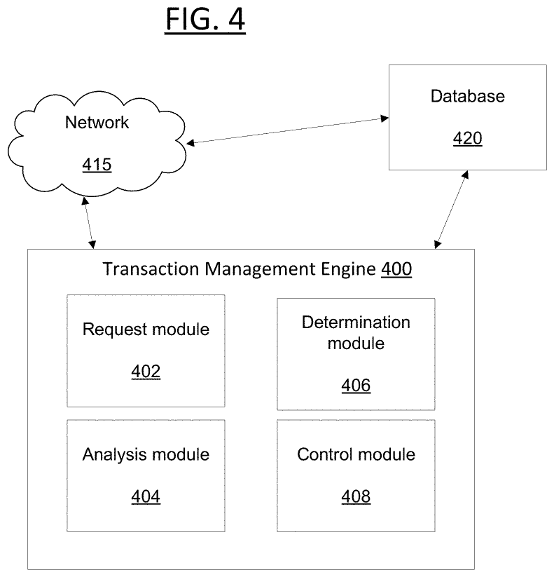

FIG. 4 is a block diagram illustrating the components of some embodiments. FIG. 4 includes transaction management engine 400, network 415 and database 420. The transaction management engine 400 can be a special purpose machine or processor and could be hosted by a cloud server (e.g., cloud web services server(s)), application server, content server, web server, search server, content provider, third party server, user's computing device, and the like, or any combination thereof.

According to some embodiments, transaction management engine 400 can be embodied as a stand-alone application that executes on a server and/or user device (e.g., on a cloud server and/or on-prem on a user device or local storage). In some embodiments, the transaction management engine 400 can function as an application installed on a device; and, in some embodiments, such application can be a web-based application accessed by a device(s) over a network. In some embodiments, engine 400 comprises functionality for integration with a private data center and/or cloud-computing service.

The database 420 can be any type of database or memory and can be associated with a content server on a network (e.g., cloud server, content server, a search server or application server) or a user's device (e.g., client devices discussed above in FIGS. 1-3). Database 420 comprises a dataset of data and metadata associated with local and/or network information related to users, services, applications, content and the like. Such information can be stored and indexed in the database 420 independently and/or as a linked or associated dataset. As discussed above, it should be understood that the data (and metadata) in the database 420 can be any type of information and type, whether known or to be known, without departing from the scope of the present disclosure.

According to some embodiments, database 420 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, user betting, user gaming, and the like, or some combination thereof.

In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 420 can be any type of information related to a user, content, a device, an application, a service provider, a content provider, whether known or to be known, without departing from the scope of the present disclosure.

According to some embodiments, database 420 can store data and metadata associated with users, searches, bets, gaming, actions, clicks, conversions, recommendations, messages, images, videos, text, products, items and services from an assortment of media, applications and/or service providers and/or platforms, and the like. Accordingly, any other type of known or to be known attribute or feature associated with a user, a game, a bet, a location, message, data item, media item, login, logout, website, application, communication (e.g., a message) and/or its transmission over a network, a user and/or content included therein, or some combination thereof, can be saved as part of the data/metadata in datastore 420.

As discussed above, with reference to FIGS. 1-2, the network 415 can be any type of network such as, but not limited to, a wireless network, a local area network (LAN), wide area network (WAN), the Internet, or a combination thereof. The network 415 facilitates connectivity of the transaction management engine 400, and the database of stored resources 420. Indeed, as illustrated in FIG. 4, the transaction management engine 400 and database 420 can be directly connected by any known or to be known method of connecting and/or enabling communication between such devices and resources.

The principal processor, server, or combination of devices that comprises hardware programmed in accordance with the special purpose functions herein is referred to for convenience as transaction management engine 400, and includes request module 402, analysis module 404, determination module 406 and control module 408. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

Turning to FIG. 5, Process 500 provides non-limiting example embodiments for electronically managing, enabling and/or controlling electronic transactions and their related data pursuant to complying with applicable regulatory laws, statutes and rules.

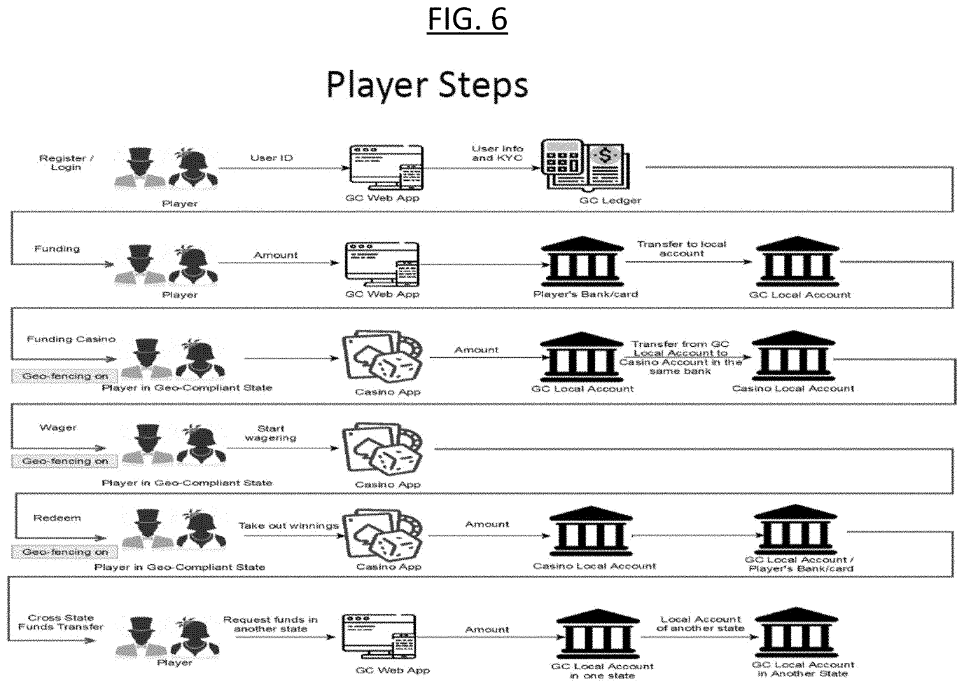

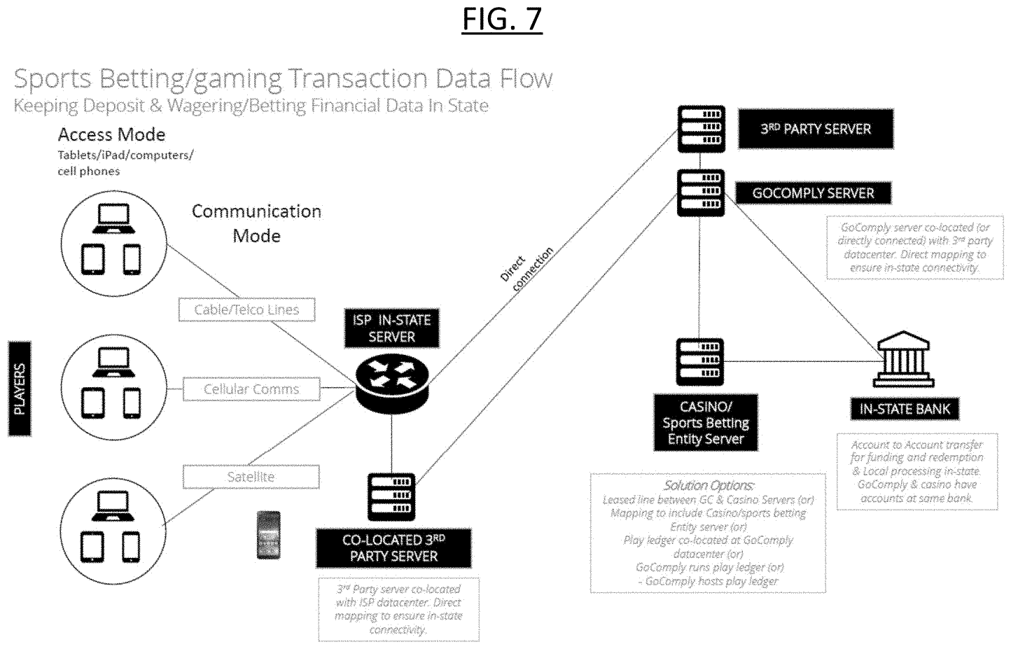

According to some embodiments, FIGS. 6-7, discussed below, provide companion discussions of the steps performed in association with Process 500. Thus, it should be understood that while Process 500 provides example embodiments for ensuring the regulatory compliance of an electronic transaction(s), the disclosed systems and methods contemplate execution of Process 500 in connection with the data flow of FIG. 6 via the electronic communications and configurations of the network environment depicted in FIG. 7.

According to some embodiments, Step 502 can be performed by request module 402 of transaction management engine 400; Step 504 can be performed by analysis module; Step 506 can be performed by determination module 408; Steps 508, 512 and 514 can be performed by control module 408; and Step 510 can be performed by analysis module 404 and/or determination module 406.

Process 500 begins with Step 502 where a request to process an electronic transaction between at least two entities over a network is received. In some embodiments, as discussed below, one entity of the transaction can be a user, and another entity can be a party that provides betting functionality (e.g., a casino, for example). Thus, in some embodiments, for example, the request in Step 502 can involve a user requesting access to a casino betting application or platform, and/or can involve the user placing an initial wager to consummate a betting transaction (or set of sequential transactions, for example, a sequence of bets).

In Step 504, the request and its associated information can be analyzed. The associated information can include, but is not limited to, information about the user (e.g., user profile information, user ID, user age, user location, and the like, or any other type of information about the user that can be stored in a database and/or accessible over a network about a user, as discussed above in relation to FIG. 4), wager amount, game type, casino location, application type, time stamp of initial wager (and each subsequent wager or bet), information related to applicable regulatory laws associated with the casino or betting platform, and the like, or some combination thereof.

In some embodiments, the request of Step 502 and the information associated with, referenced therein and/or included within can be analyzed in Step 504 by engine 400 executing any type of known or to be known computational analysis technique on the request and the data included therein and/or associated therewith, including but not limited to, vector analysis, data mining, computer vision, machine learning, neural network, artificial intelligence, and the like, or some combination thereof.

As a result of Step 504's analysis, engine 400 is capable of determining a geo-fence for which the transaction can be performed. In some embodiments, the geo-fence can be defined according to, but not limited to, a municipal boundary (e.g., state, county, city, town, country and the like), a radius around the user's location, a radius around the casino's location, a region of movement allotted to a user (e.g., when betting or gaming on a moving vehicle, for example, a riverboat, ship or airplane), and the like, or some combination thereof.

Thus, according to some embodiments, Step 506 enables a geo-fence to be applied so that the transaction is limited and/or restricted to be being performed within a geographic area (e.g., which can be any type of defined geographic area, whether corresponding to predetermined boundaries of a map or corresponding to dynamically determined boundaries associated with the user, the casino and/or type of transaction, and the like).

In some embodiments, the determined geo-fence can correspond to a single geographic area. In some embodiments, the geo-fence can correspond to multiple geographic areas. For example, if the user is requesting to gamble via the casino betting application of Casino X, and Casino X's gambling is enabled in both state X and state Y in the USA, then, two geofences can be applied that enable the user to perform transactions while within each state (and deny such transactions when outside of those two states), as discussed below.

In some embodiments, information related to the transaction, the applied geo-fence and the user can be stored in a database (e.g., database 420) so that the transaction can be enabled and monitored for compliance with the applicable rules of the applied geo-fence.

Process 500 then proceeds to Step 508 after applying the geo-fence to the transaction. In Step 508, the user commences executing the transaction (or series of related transactions, for example, playing a plurality of hands of Blackjack via a betting application). Engine 400 enables these transactions to be performed based on the application of the geo-fence so as to ensure regulatory compliance, as discussed above.

In some embodiments, Step 508 can involve tagging each transaction or at least a portion of each transaction or the packets associated with communications of each transaction (e.g., IP address data). In some embodiments, engine 400 can analyze and apply a packet tagging algorithm or program (e.g., OpenBSB packet tagging/filtering, and the like) that can mark and/or annotate packets associated with electronic communications with an internal identifier that can be used to filter and/or discern whether they comply with particular criteria (e.g., whether their location originated from and/or concluded at a location within the geo-fence).

In some embodiments, in addition to or in the alternative to tagging packets of transactions, a user's application usage (e.g., the login event associated with the request 502 and/or the initiation of the request 502) can be subject to such packet tagging so that the user's usage of the betting application can be subject to the proper scrutiny to ensure that its usage is not outside the geo-fence. In some embodiments, when virtual private networks (VPNs) are used by the user to connect to a network (e.g., Internet), then engine 400 can tag the user via the application level tagging since tracking the communications may not be trustworthy.

In Step 510, engine 400 can track and monitor the transactions of the user to determine if they are maintained within the geo-fence. In some embodiments, this can involve using the packet tracking capabilities executed by engine 400, as discussed above. In some embodiments, engine 400's monitoring is performed according to a time period, which can be, in real-time (or substantially real-time), or according to a predetermined, randomly assigned or dynamically determined time period, which can be set and/or adjusted based on information provided by a user, a casino, an administrator, a law official, a gaming administrator, and the like, or some combination thereof. Such information can correspond to a wager amount, game type (e.g., monitor each time the cards are dealt in a game of Blackjack, for example), a threshold period of time has passed since the last monitoring event, and the like.

When it is determined that the transaction is being maintained within the geo-fence, Process 500 proceeds from Step 510 to Step 514 where the transaction is enabled to continue in an uninterrupted manner until its completion (or until a subsequent monitoring processing is performed, as discussed above).

When it is determined that at least a portion of the transaction is associated with a location that falls outside of the geo-fence (e.g., a packet related to a wager or payout was transmitted and/or received by engine 400 and its geographic data indicates a location that is outside of the physical confines of the defined geo-fence), Process 500 proceeds from Step 510 to Step 512. In Step 512, engine 400 is configured to be able to stop the transaction entirely or at least cancel or nullify the portion that corresponds to the geo-fence outlier. In some embodiments, as a result of Step 512, engine 400 can request further information from the user to determine the user's adherence to the geo-fence (e.g., request current GPS data of the user's device that is executing the casino/betting application). In some embodiments, engine 400 can cancel the entire transaction by refunding the entirety of funds to the originating parties thereby nullifying the entirety of the transaction's performed by the user (and/or casino). In some embodiments, upon Process 500 proceeding to Step 512, engine 400 may require Process 500 to restart again at Step 502 for a new set of transactions for the user so that a new or readjusted/updated geo-fence can be used.

As shown in FIG. 6, in some embodiments, a user (also referred to as a player as a non-limiting example herein) first registers as a user of the system. After registration, the user receives a user ID which can be used to log into a web (or other) application (“web application”.) The user information and other Know Your Customer (KYC) information is sent to a ledger in some embodiments.

In some embodiments, funding can then take place and be registered in the web application and transferred to a user's bank, card or other financial storage location or device. In some embodiments, the funding is then transferred to a local account.

In some embodiments, a casino or other desired account can be funded only after conventional geo-fencing techniques ensure the user is in a geo-compliant geographical area such as a state or country. A casino or other application may be used to transfer all or a portion of the original funding amount to the casino or other business or entity. In some embodiments, to comply with regulations which require all transactions to be conducted within a certain geographic area such as a state, all transfers are conducted within that geographic area as guided by geo-fencing parameters and systems.

In some embodiments, a wager is also required to be geo-compliant, with the system ensuring the user is in the correct geographic area to comply with regulatory requirements. A casino or other app may be used in for this purpose, either with its own functionality or in combination with other systems.

In some embodiments, redemption of winnings is also subject to geo-fencing processes, ensuring those transactions are also located in the correct geographic area. Local accounts for both the casino (or other business or entity) can be used to continue to ensure regulatory compliance.

In some embodiments, the system can also offer cross state funds transfer capabilities. Funds can be requested in a state or geographic area different from the previous steps and can be transferred between local accounts in each state.

FIG. 7 shows a transaction data flow which can used to implement some or all of the previously described functions in some embodiments. As shown, a wide variety of devices can be used to access the system. Co-located servers can be used to ensure in-state (or other geographic area) connectivity in some embodiments.

In some embodiments, a direct connection between the servers and one or more third party servers is provided. In some embodiments, the third party server is coupled to and co-located with a regulatory-focused server which can receive geo-fencing and/or related information. In some embodiments, the regulatory server can be coupled to servers hosted or administered by a casino (or other desired business or entity.)

Ledgers can be co-located at a regulatory server or can be run or hosted by a regulatory-focused entity. In-state banks can be coupled to the system and can provide accounts for both the casino (or other business or entity) and the regulatory-focused entity.

Accordingly, in some embodiments, every transaction which is required to be conducted within a certain geographic area can be shown to have taken place as required by relevant laws and regulations. In some embodiments, a robust audit trail can be provided to regulators as desired.

The subject matter described herein are directed to technological improvements to the field of artificial intelligence by proving artificial intelligence driven industrial reference recognition software that takes less computing resources to train and execute. The disclosure describes the specifics of how a machine including one or more computers comprising one or more processors and one or more non-transitory computer implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide a technologic improvements advantages not known in the prior art. Furthermore, the system includes unconventional steps that confine the claim to a useful application.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the additional meaning to the following terms:

“Substantially” and “approximately” when used in conjunction with a value encompass a difference of 5% or less of the same unit and/or scale of that being measured. In some embodiments, “substantially” and “approximately” are defined as presented in the specification in accordance with some embodiments.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, some embodiments recited with term “can” or “may” or derivations there of (e.g., the system display can show X) is for descriptive purposes only and is understood to be synonymous with “configured to” (e.g., the system display is configured to show X) for defining the metes and bounds of the system.

Any of the operations described herein that form part of the present disclosure are useful machine operations. The present disclosure also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

Some embodiments can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A method comprising:
receiving, by a device over a network, a request from a user to perform a transaction, the transaction corresponding to an electronic gaming event associated with an entity accessible via the network;
analyzing, by the device, information related to the requested transaction;
determining and applying, by the device, a geo-fence to the transaction, the geo-fence corresponding to a defined geographic region for which the transaction is permitted to be executed;
enabling, by the device, the transaction based on the applied geo-fence;
monitoring, by the device, the enabled transaction; and
determining, by the device, based on the monitoring of the transaction, whether performance of the transaction is maintained within the geo-fence, wherein:
the device halts the transaction when the determination indicates at least a portion of the transaction has occurred or is occurring outside of the geo-fence, and
the device enables and continues monitoring the transaction until its completion when the determination indicates an entirety of the transaction is being performed within the geo-fence.

2. A device comprising:
a processor configured to:
receive, over a network, a request from a user to perform a transaction, the transaction corresponding to an electronic gaming event associated with an entity accessible via the network;
analyze information related to the requested transaction;
determine and apply a geo-fence to the transaction, the geo-fence corresponding to a defined geographic region for which the transaction is permitted to be executed;
enable the transaction based on the applied geo-fence;
monitor the enabled transaction; and
determine, based on the monitoring of the transaction, whether performance of the transaction is maintained within the geo-fence, wherein:
halt the transaction when the determination indicates at least a portion of the transaction has or is occurring outside of the geo-fence, and
enable and continue monitoring the transaction until its completion when the determination indicates an entirety of the transaction is being performed within the geo-fence.

3. A non-transitory computer-readable storage medium tangibly encoded with computer-executable instructions, that when executed by a device, performs a method comprising:
receiving, by the device over a network, a request from a user to perform a transaction, the transaction corresponding to an electronic gaming event associated with an entity accessible via the network;
analyzing, by the device, information related to the requested transaction;
determining and applying, by the device, a geo-fence to the transaction, the geo-fence corresponding to a defined geographic region for which the transaction is permitted to be executed;
enabling, by the device, the transaction based on the applied geo-fence;
monitoring, by the device, the enabled transaction; and
determining, by the device, based on the monitoring of the transaction, whether performance of the transaction is maintained within the geo-fence, wherein:
the device halts the transaction when the determination indicates at least a portion of the transaction has or is occurring outside of the geo-fence, and
the device enables and continues monitoring the transaction until its completion when the determination indicates an entirety of the transaction is being performed within the geo-fence.
